(19) United States
(12) Patent Application Publication
(10) Pub. No.: US 2025/0346078 A1
(43) Pub. Date: Nov. 13, 2025

(54) VEHICLE COUPLING SYSTEM

(71) Applicant: Oshkosh Corporation, Oshkosh, WI (US)

(72) Inventors: Devin Rosencrance, Oshkosh, WI (US); Samuel Nessibu, Oshkosh, WI (US); Guido Ritelli, Oshkosh, WI (US); Tyler Walsh, Oshkosh, WI (US); Patrick Dingman, Oshkosh, WI (US)

(73) Assignee: Oshkosh Corporation, Oshkosh, WI (US)

(21) Appl. No.: 19/086,544

(22) Filed: Mar. 21, 2025

Related U.S. Application Data
(60) Provisional application No. 63/643,631, filed on May 7, 2024.
(60) Provisional application No. 63/643,723, filed on May 7, 2024.
(60) Provisional application No. 63/643,653, filed on May 7, 2024.
(60) Provisional application No. 63/643,528, filed on May 7, 2024.
(60) Provisional application No. 63/643,627, filed on May 7, 2024.
(60) Provisional application No. 63/643,608, filed on May 7, 2024.
(60) Provisional application No. 63/643,788, filed on May 7, 2024.
(60) Provisional application No. 63/643,617, filed on May 7, 2024.
(60) Provisional application No. 63/643,541, filed on May 7, 2024.
(60) Provisional application No. 63/712,602, filed on Oct. 28, 2024.
(60) Provisional application No. 63/713,023, filed on Oct. 28, 2024.
(60) Provisional application No. 63/712,621, filed on Oct. 28, 2024.
(60) Provisional application No. 63/712,647, filed on Oct. 28, 2024.
(60) Provisional application No. 63/712,662, filed on Oct. 28, 2024.
(60) Provisional application No. 63/741,710, filed on Jan. 3, 2025.
(60) Provisional application No. 63/741,768, filed on Jan. 3, 2025.
(60) Provisional application No. 63/775,273, filed on Mar. 20, 2025.

(51) Int. Cl. B60D 1/155; B60D 1/62

(52) U.S. Cl. CPC B60D 1/155; B60D 1/62

(57) ABSTRACT

A vehicle coupling system includes a first vehicle, a second vehicle, and a tow bar. The first vehicle includes a drive motor configured to propel the first vehicle and a lifting implement configured to support a product for movement. The second vehicle includes a lifting implement configured to support the product for movement. The tow bar is coupled to the first vehicle at a first end of the tow bar and coupled to the second vehicle at a second end of the tow bar opposite the first end. Responsive to the drive motor propelling the first vehicle, the tow bar exerts a force on the second vehicle to maintain a space between the second vehicle and the first vehicle.

### CROSS-REFERENCE TO RELATED PATENT APPLICATION

This application claims the benefit of and priority to (a) U.S. Provisional Patent Application 63/643,653, filed on May 7, 2024, (b) U.S. Provisional Patent Application 63/643,631, filed on May 7, 2024, (c) U.S. Provisional Patent Application 63/643,541, filed on May 7, 2024, (d) U.S. Provisional Patent Application 63/643,627, filed on May 7, 2024, (e) U.S. Provisional Patent Application 63/643,723, filed on May 7, 2024, (f) U.S. Provisional Patent Application 63/643,528, filed on May 7, 2024, (g) U.S. Provisional Patent Application 63/643,788, filed on May 7, 2024, (h) U.S. Provisional Patent Application 63/643,617, filed on May 7, 2024, (i) U.S. Provisional Patent Application 63/643,608, filed on May 7, 2024, (j) U.S. Provisional Patent Application 63/712,602, filed on Oct. 28, 2024, (k) U.S. Provisional Patent Application 63/712,621, filed on Oct. 28, 2024, (1) U.S. Provisional Patent Application 63/713,023, filed on Oct. 28, 2024, (m) U.S. Provisional Patent Application 63/712,662, filed on Oct. 28, 2024, (n) U.S. Provisional Patent Application 63/712,647, filed on Oct. 28, 2024, (o) U.S. Provisional Patent Application 63/741,768, filed on Jan. 3, 2025, (p) U.S. Provisional Patent Application 63/741,710, filed on Jan. 3, 2025, and (q) U.S. Provisional Patent Application 63/775,273, filed on Mar. 20, 2025, each of which is incorporated herein by reference in its entirety.

### BACKGROUND

The present disclosure relates generally to vehicles. More specifically, the present disclosure relates to vehicles utilized to transport material.

In a manufacturing environment, products are moved along a manufacturing line as various assembly processes are performed. In some such embodiments, the products are supported and/or propelled by vehicles. These vehicles may have varying ways of supporting the products and may incorporate varying levels of autonomy.

### SUMMARY

One embodiment relates to a vehicle coupling system. The vehicle coupling system includes a first vehicle, a second vehicle, and a tow bar. The first vehicle includes a chassis, a plurality of tractive elements coupled to the chassis, the plurality of tractive elements configured to engage a ground surface to support the first vehicle, a drive motor configured to drive one or more of the plurality of tractive elements to propel the first vehicle, and a lifting implement configured to support a product for movement via the drive motor. The second vehicle includes a chassis, a plurality of tractive elements coupled to the chassis, the plurality of tractive elements configured to engage the ground surface to support the second vehicle, and a lifting implement configured to support the product for movement. The tow bar is coupled to the first vehicle at a first end of the tow bar and coupled to the second vehicle at a second end of the tow bar opposite the first end. Responsive to the drive motor propelling the first vehicle, the tow bar exerts a force on the second vehicle to maintain a space between the second vehicle and the first vehicle.

Another embodiment relates to a vehicle coupling system. The vehicle coupling system includes a first vehicle, a second vehicle, a conduit, and a conduit management system. The first vehicle includes a chassis, a plurality of tractive elements coupled to the chassis, the plurality of tractive elements configured to engage a ground surface to support the first vehicle, a drive motor configured to drive one or more of the plurality of tractive elements to propel the first vehicle, and a lifting implement configured to support a product for movement via the drive motor. The second vehicle includes a chassis, a plurality of tractive elements coupled to the chassis, the plurality of tractive elements configured to engage the ground surface to support the second vehicle, and a lifting implement configured to support the product for movement. The conduit couples the first vehicle with the second vehicle. The conduit is configured to transfer at least one of (i) electrical energy, (ii) fluid power, or (iii) information between the first vehicle and the second vehicle. The conduit management system is configured to support a portion the conduit extending across a space defined by a distance between the first vehicle and the second vehicle.

Still another embodiment relates to a vehicle coupling system. The vehicle coupling system includes a first vehicle, a second vehicle, and a tow bar. The first vehicle includes a chassis, a plurality of tractive elements coupled to the chassis, the plurality of tractive elements configured to engage a ground surface to support the first vehicle, a drive motor configured to drive one or more of the plurality of tractive elements to propel the first vehicle, and a lifting implement configured to support a product for movement via the drive motor. The second vehicle includes a chassis, a plurality of tractive elements coupled to the chassis, the plurality of tractive elements configured to engage the ground surface to support the second vehicle, and a lifting implement configured to support the product for movement. The tow bar includes a first portion pivotably coupled to the first vehicle, a second portion coupled to the second vehicle, and a third portion extending between the first portion and the second portion, the third portion being laterally offset from a lateral center axis of the first vehicle and the second vehicle. Responsive to the drive motor propelling the first vehicle, the tow bar exerts a force on the second vehicle to maintain a space between the second vehicle and the first vehicle. The third portion of the tow bar includes two or more members telescopically coupled to each other to accommodate for a change in a distance of the space between the second vehicle and the first vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a perspective view of a vehicle according to an exemplary embodiment.

FIG. 2 is a top view of the vehicle of FIG. 1.

FIG. 3 is a perspective view of the vehicle of FIG. 1 equipped with a lifting implement, according to an exemplary embodiment.

FIG. 4 is a perspective view of the vehicle of FIG. 3 and another vehicle cooperating to support a telehandler, according to an exemplary embodiment.

FIG. 5 is a perspective view of the vehicle of FIG. 1 equipped with a cart implement, according to an exemplary embodiment.

FIG. 6 is a perspective view of the vehicle of FIG. 3 interfacing with a cart supporting a boom assembly, according to an exemplary embodiment.

FIG. 7 is a block diagram of a control system for the vehicle of FIG. 1.

FIG. 8 is a top view of a production system including the vehicle of FIG. 1, according to an exemplary embodiment.

FIG. 9 is a perspective view of the vehicle of FIG. 3 and a skate cooperating to support the telehandler, and a tow bar coupling the vehicle of FIG. 3 with the skate, according to an exemplary embodiment.

FIG. 10 is a top view of the vehicle of FIG. 3 and the skate of FIG. 9 cooperating to support the telehandler, and the tow bar of FIG. 9, according to an exemplary embodiment.

FIG. 11 is a bottom perspective view of the skate of FIG. 9, according to an exemplary embodiment.

FIG. 12 is a rear perspective view of the skate of FIG. 9, according to an exemplary embodiment.

FIG. 13 is a section view of the tow bar of FIG. 9, according to an exemplary embodiment.

FIG. 14 includes various side views of a conduit management system supporting a conduit coupling the vehicle of FIG. 3 with the skate of FIG. 9, according to an exemplary embodiment.

FIG. 15 is a perspective view of a conduit management system supporting a conduit coupling the vehicle of FIG. 3 with the skate of FIG. 9, according to an exemplary embodiment.

FIG. 16 is a side view of a conduit management system including a pulley system for routing a conduit within the skate of FIG. 9, according to an exemplary embodiment.

FIG. 17 is a perspective view of the pulley system of FIG. 16, according to an exemplary embodiment.

FIG. 18 is a block diagram of a control system for the skate of FIG. 9.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the figures, a first vehicle may be utilized with a second vehicle to cooperatively operate to support a product and facilitate moving the product (e.g., through various stages of assembly). The first vehicle may include a drive motor to propel the first vehicle along a ground surface with which the first vehicle is engaged. The first vehicle may be coupled with the second vehicle with a tow bar extending therebetween. The tow bar may be pivotally coupled with the first vehicle and fixedly coupled with the second vehicle. In response to the drive motor propelling the first vehicle, the tow bar exerts a force on the second vehicle to maintain a distance between the first vehicle and the second vehicle. In this manner, the second vehicle does not include a drive motor, and is instead driven by the coupling with the first vehicle via the tow bar.

The products carried by the first vehicle and the second vehicle may have varying lengths. A distance between the first vehicle and the second vehicle may change based on the length of the product to be carried thereby. To accommodate for the change in the distance between the first vehicle and the second vehicle (and the varying lengths of the products), the tow bar may include two or more members telescopically coupled to each other to enable varying a length of the tow bar.

The first vehicle and the second vehicle may be coupled together by a conduit configured to transfer at least one of (i) electrical energy, (ii) fluid power, or (iii) information between the first cart and the second cart. By way of example, the first vehicle may transfer, via the conduit, electrical energy from batteries of the first vehicle to power one or more components of the second vehicle. By way of another example, the first vehicle may transfer, via the conduit, fluid power from a hydraulic system to fluidly power one or more components of the second vehicle. By way of yet another example, the first vehicle may transfer, via the conduit, data associated with the operation of the first vehicle to the second vehicle (e.g., to control one or more components of the second vehicle). A conduit management system may be used to support a portion the conduit extending across a space defined by a distance between the first vehicle and the second vehicle. By way of example, the conduit may be routed through an interior cavity of the tow bar to couple (e.g., electrically couple, fluidly couple, and/or communicably couple) the first vehicle and the second vehicle to each other.

### Overall Vehicle

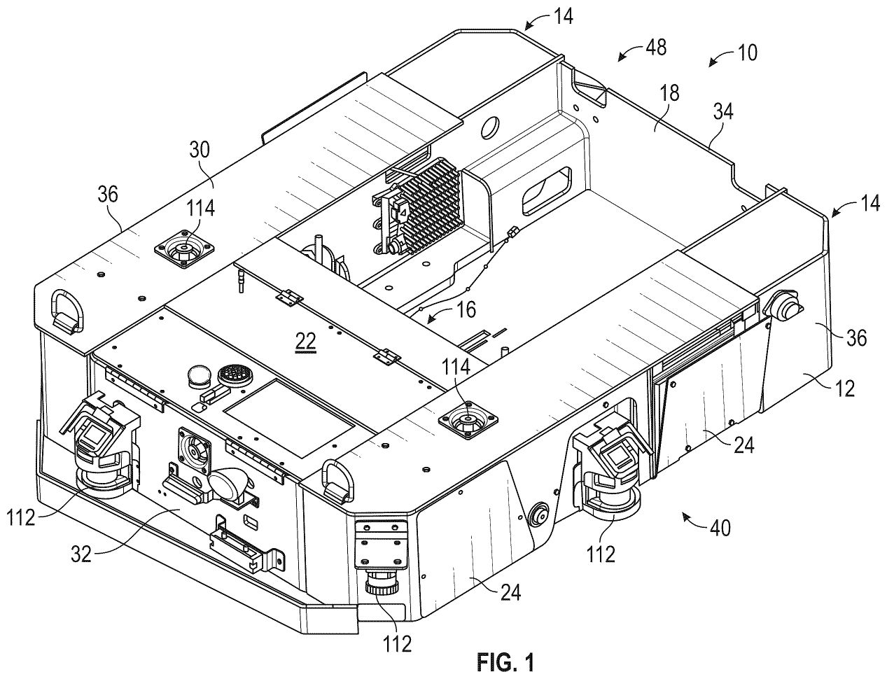

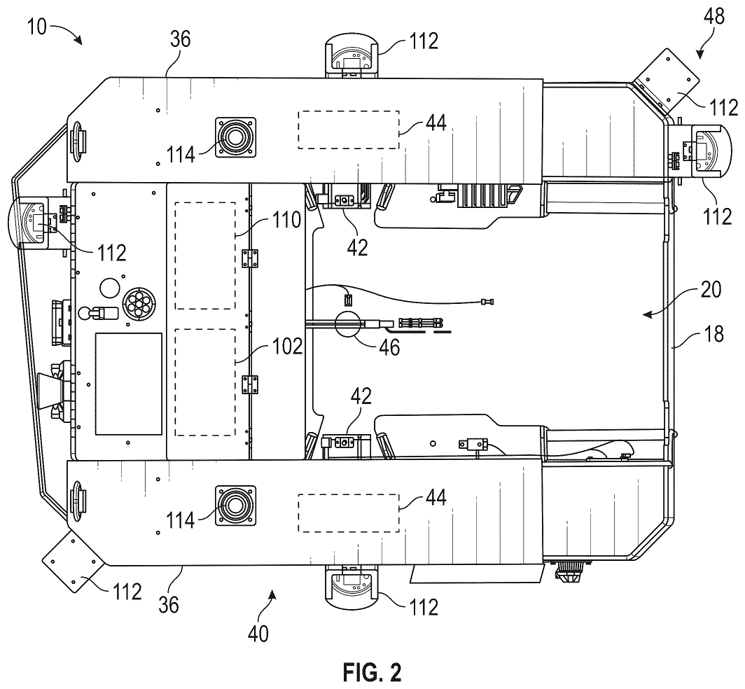

Referring to FIGS. 1 and 2, a machine, vehicle, trolley, transport, hauler, mule, or tug, is shown as vehicle 10 according to an exemplary embodiment. The vehicle 10 may be configured to support, push, pull, turn, or otherwise facilitate movement of a product or components of a product throughout a manufacturing environment. By way of example, the vehicle 10 may move a product (e.g., another vehicle or machine) along a manufacturing line as the product is assembled. The vehicle 10 may move the product between stations where different assembly operations are performed. Additionally or alternatively, the vehicle 10 may be used to move parts or subassemblies (e.g., booms, engines, tires, etc.) throughout the manufacturing environment (e.g., to the product, to a storage area, etc.).

The vehicle 10 may be manually controlled, partially autonomous, or fully autonomous. In some embodiments, the vehicle 10 is configured as a semi-automated guided vehicle (SGV). When configured as an SGV, the vehicle 10 may be manually operated by an operator (e.g., through a wireless or tethered user interface). By way of example, the operator may manually control the steering of the vehicle 10. In some embodiments, the vehicle 10 is configured as an automated guided vehicle (AGV). When configured as an AGV, the vehicle 10 may navigate along a predefined route (e.g., using a magnetic strip or other fixed navigation element). If the vehicle 10 configured as an AGV encounters an obstacle, the vehicle 10 may rely on manual intervention from an operator (e.g., through a user interface) to correct course and navigate around the obstacle. In some embodiments, the vehicle 10 is configured as an autonomous mobile robot (AMR). When configured as an AMR, the vehicle 10 may autonomously navigate through an area without requiring a predefined path. The vehicle 10 configured as an AMR may avoid obstacles without manual intervention by an operator.

The vehicle 10 includes a chassis, shown as frame 12, that supports the other components of the vehicle 10. In some embodiments, the frame 12 defines an enclosure that contains one or more components of the vehicle 10. The frame 12 includes a pair of side portions, shown as drive modules 14, a central portion, shown as controls enclosure 16, and a lateral member, shown as back plate 18. The drive modules 14 each extend longitudinally along the vehicle 10 and are laterally offset from one another. The controls enclosure 16 and the back plate 18 each extend laterally between the drive modules 14, fixedly coupling the drive modules 14 to one another. The controls enclosure 16 and the back plate 18 are longitudinally offset from one another, such that a recess or passage, shown as implement recess 20, is defined between the controls enclosure 16, the back plate 18, and the drive modules 14.

The drive modules 14 may contain components that facilitate propulsion of the vehicle (e.g., the drivetrain 40). The drive modules 14 may include one or more removable or repositionable panels, shown as drive module doors 24, that facilitate access to components within the drive modules 14 from outside of the vehicle 10. The controls enclosure 16 may contain components that facilitate powering or control over the vehicle (e.g., the controller 102, the batteries 110). The controls enclosure 16 includes a removable or repositionable panel, shown as controls enclosure door 22, that facilitates access to components within the controls enclosure 16 from outside of the vehicle 10. In other embodiments, the vehicle 10 includes a separate housing, body, or enclosure that is coupled to the frame 12 and contains one or more components of the vehicle.

The frame 12 defines a top surface 30, a front surface 32, a rear surface 34, and a pair of side surfaces 36 of the vehicle 10. The top surface 30 extends substantially horizontally across the drive modules 14 and the controls enclosure 16. A distance from the top surface 30 to the ground beneath the vehicle 10 may define a height of the vehicle 10. The front surface 32 is positioned at a front end portion of the frame 12 and extends substantially vertically and laterally across the drive modules 14 and the controls enclosure 16. The rear surface 34 is positioned at a rear end portion of the frame 12 and extends substantially vertically and laterally across the drive modules 14 and the back plate 18. The side surfaces 36 each extend longitudinally along one of the drive modules 14, between the front surface 32 and the rear surface 34.

The vehicle 10 includes a drive system or driveline, shown as drivetrain 40, that is configured to propel and steer the vehicle 10. The driveline includes a pair of actuators or motors (e.g., hydraulic motors, pneumatic motors, electric motors, etc.), shown as drive motors 42. In some embodiments, the drive motors 42 are electric motors powered by an electrical energy source (e.g., the batteries 110, energy from a power grid external to the vehicle 10, etc.). The drive motors 42 are each configured to provide rotational mechanical energy to drive rotation of one or more tractive elements 44 (e.g., wheel and tire assemblies). In some embodiments, the drive motors 42 drive the left and right sides of the drivetrain 40 independently, facilitating skid steer operation of the vehicle 10. By way of example, the tractive elements 44 may be driven at the same speed and in the same direction to travel straight. By way of another example, the tractive elements 44 may be driven at different directions and/or at different speeds to turn the vehicle 10. By driving the tractive elements 44 at the same speed and in opposite directions, the drivetrain 40 may rotate the vehicle 10 about a substantially vertical axis, shown as central axis 46, that is substantially centered relative to the frame 12. Rotation of the vehicle 10 about the central axis 46 may facilitate reorienting the vehicle 10 without changing position (i.e., turning in place).

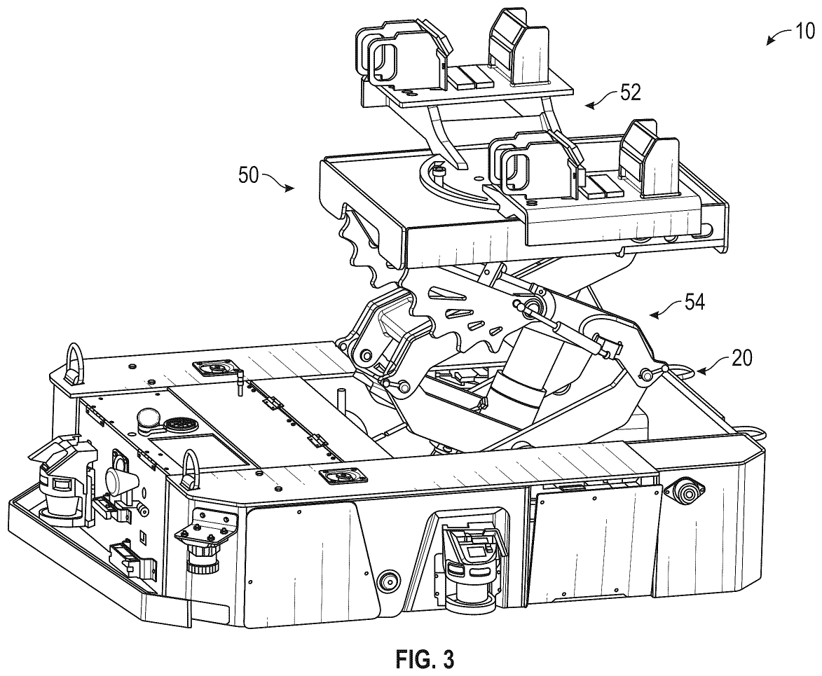

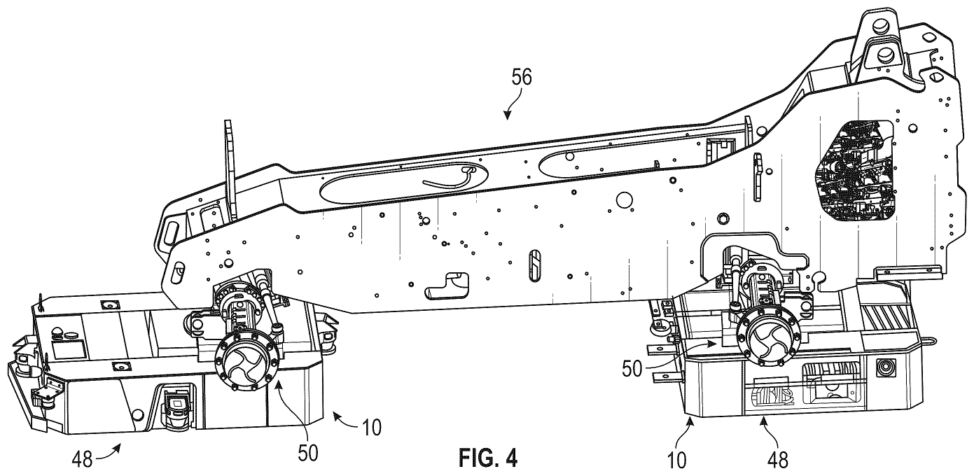

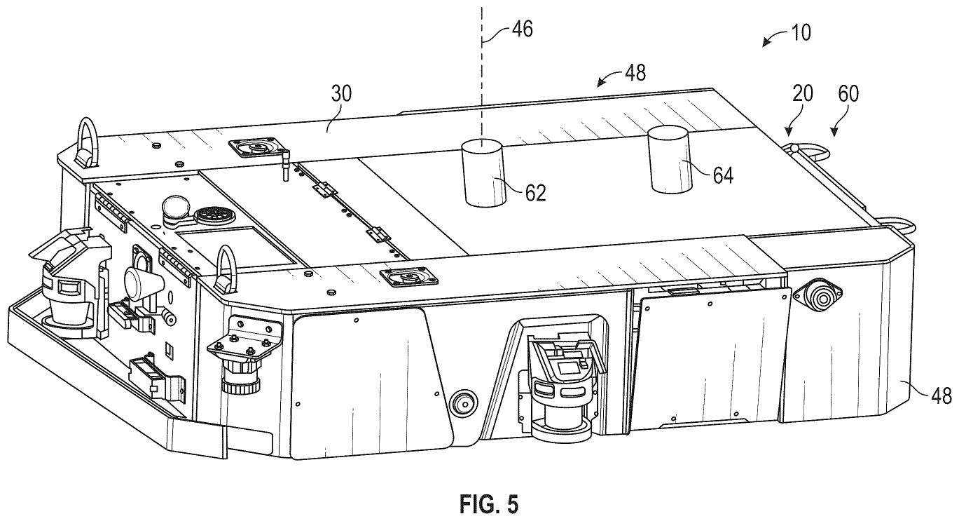

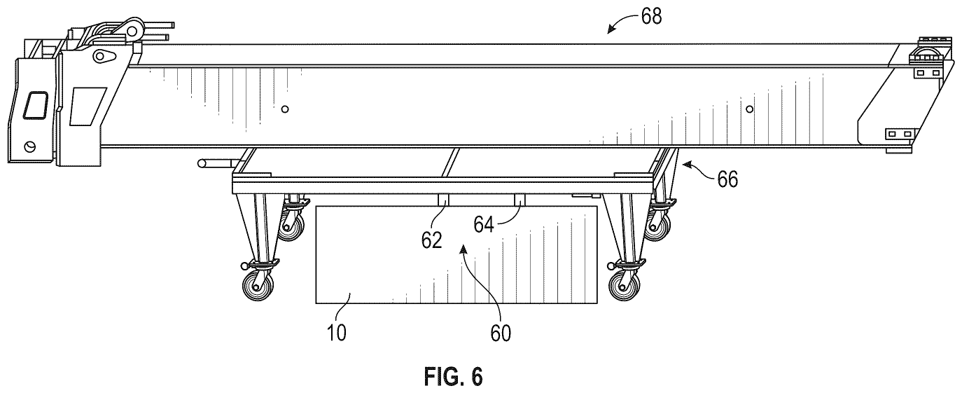

The frame 12, the drivetrain 40, and various other components coupled to the frame 12 form a base portion of the vehicle 10, shown as base assembly 48. To facilitate moving a product, the vehicle 10 may include an implement that that selectively couples the base assembly 48 to a product. FIGS. 3 and 4 illustrate a first implement, shown as lifting implement 50, and FIGS. 5 and 6 illustrate a second implement, shown as cart implement 60. Each implement may be received within the implement recess 20 and fixedly coupled to the frame 12. In some embodiments, the implement is removable from the implement recess 20 to facilitate interchanging with another type of implement. By way of example, the lifting implement 50 may be removed and replaced with the cart implement 60. In other embodiments, the implement is permanently installed on the vehicle.

Referring to FIGS. 3 and 4, the lifting implement 50 includes a product interface, shown as cradle 52, and a lift device or lifting assembly, shown as lift assembly 54. The cradle 52 is configured to receive and directly support a product, shown as telehandler 56. By way of example, the cradle 52 may receive an axle assembly of the telehandler 56. The lift assembly 54 couples the cradle 52 to the frame 12. The lift assembly 54 may be extended to raise the cradle 52 or retracted to lower the cradle 52. Accordingly, the lift assembly 54 may be used to raise or lower the telehandler 56.

Certain large products, such as the telehandler 56, may be difficult to support with only a single vehicle 10. To facilitate steering the product and spreading out the weight of the product, multiple vehicles 10 may be utilized. In the example shown in FIG. 4, a front axle of the telehandler 56 is supported by one vehicle 10, and a rear axle of the telehandler 56 is supported by another vehicle 10. In some embodiments, the vehicles 10 are independently operable. In other embodiments, operation of one vehicle 10 is dependent upon the other vehicle 10. By way of example, a first vehicle 10 may supply electrical energy to, propel, and/or control operation of the other vehicle 10.

Referring to FIGS. 5 and 6, the cart implement 60 includes a pair of protruding interface elements (e.g., pins), extending above the top surface 30. Specifically, the cart implement 60 includes a central pin, shown as driving pin 62, and an offset pin, shown as turning pin 64, that can each be selectively raised and lowered by an actuator of the cart implement 60. The driving pin 62 is centered about the central axis 46, and the turning pin 64 is offset from the central axis 46. The driving pin 62 and the turning pin 64 are positioned to a mobile platform, shown as cart 66, that supports a product subassembly, shown as boom assembly 68.

When extended, the driving pin 62 and the turning pin 64 each engage the cart 66 to limit movement of the cart 66 relative to the base assembly 48. When both the driving pin 62 and the turning pin 64 engage the cart 66, the cart 66 may be fixed to the base assembly 48. When only the driving pin 62 engages the cart 66, the base assembly 48 may rotate freely about the central axis 46 relative to the cart 66, but movement of the vehicle 10 in a particular direction may cause movement of the cart 66 in that same direction. When the driving pin 62 and the turning pin 64 are both retracted away from the cart 66, the vehicle 10 may move freely relative to the cart 66.

The cart 66 may be equipped with casters or slides to facilitate free movement of the cart 66 along the ground. In some embodiments, the cart 66 supports some or all of the weight of the boom assembly 68. The driving pin 62 and the turning pin 64 may generally push horizontally on the cart 66, such that there may be little or no transmission of vertical forces between the cart implement 60 and the cart 66. Accordingly, the vertical load on the vehicle 10 may be minimized while still permitting the vehicle 10 move the cart 66 and the boom assembly 68 throughout the environment as desired. This reduction in load may reduce the overall cost of the vehicle 10.

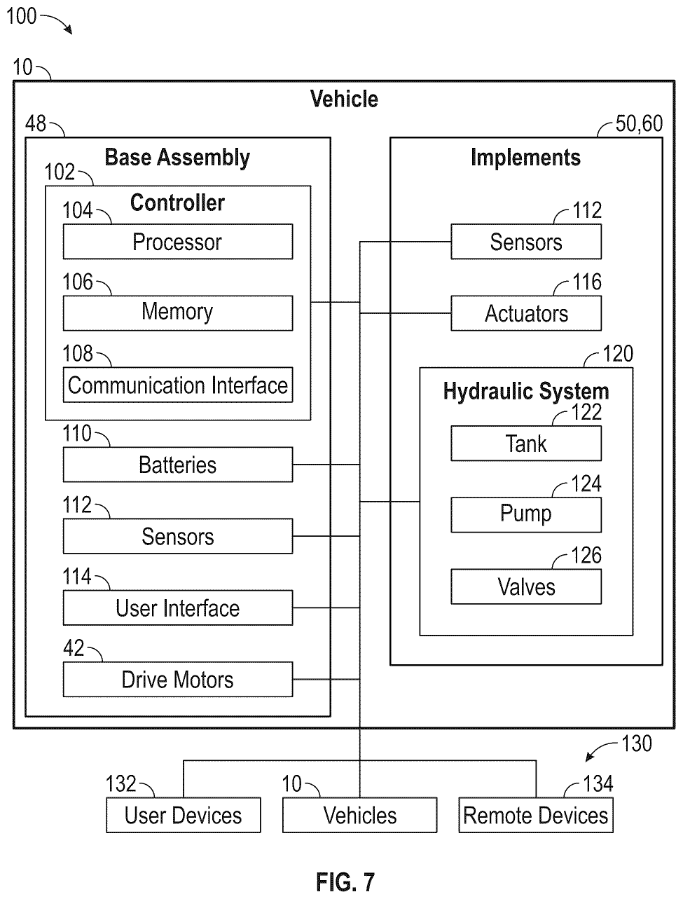

Referring to FIG. 7, the vehicle 10 and a control system 100 for the vehicle 10 are shown according to an exemplary embodiment. The control system 100 may facilitate operation of the vehicle 10 and/or other devices of a production environment. Although certain components are shown as being included in the base assembly 48 and/or the implements 50 and 60, it should be understood that any component may be positioned in the base assembly 48, the lifting implement 50, or the cart implement 60 or duplicated across multiple thereof.

The vehicle 10 includes a controller 102 that controls operation of the vehicle 10. The controller 102 includes a processing circuit, shown as processor 104, and a memory device, shown as memory 106. The memory 106 may contain one or more instruction that, when executed by the processor 104, cause the processor to perform the various functions described herein.

The controller 102 further includes a communication interface 108 (e.g., a communication circuit, a network interface, etc.) that facilitates communication with (e.g., to and from) other components of the vehicle 10 and/or the control system 100. The communication interface 108 may facilitate wired communication (e.g., through CAN, Ethernet, communication of power, etc.). Additionally or alternatively, the communication interface 108 may facilitate wireless communication (e.g., through Bluetooth, Wi-Fi, radio transmission, inductive transmission of energy, etc.).

The base assembly 48 includes one or more energy storage devices, shown as batteries 110. The batteries 110 store energy (e.g., as chemical energy). The batteries 110 may deliver electrical energy to other components of the vehicle 10 to power the vehicle 10. The batteries 110 may be charged by an outside source of energy (e.g., an electrical grid, a wireless charging interface, etc.). In other embodiments, the base assembly 48 includes a different type of energy storage device (e.g., a fuel tank for an internal combustion engine of a generator, a fuel cell, etc.).

The base assembly 48, the lifting implement 50, and the cart implement 60 may each include one or more sensors 112 operatively coupled to the controller 102. The sensors 112 may provide sensor data describing the current status of the vehicle 10 and/or the surrounding environment. By way of example, the sensors 112 may include mapping or imaging sensors (e.g., LIDAR sensors, light curtains, cameras, ultrasonic sensors, etc.). By way of example, the sensors 112 may include position sensors (e.g., GPS, potentiometers, encoders, etc.). By way of example, the sensors 112 may include orientation or acceleration sensors (e.g., accelerometers, gyroscopic sensors, inertial measurement units, compasses, etc.). By way of example, the sensors 112 may include pressure sensors, flowmeters, buttons, or other types of sensors.

The base assembly 48 may include one or more operator interface elements (e.g., input devices, output devices, etc.), shown as user interface 114. The user interface 114 may include output devices that provide information to one or more users. By way of example, the user interface 114 may include displays, speakers, lights, haptic feedback (e.g., vibrators, etc.), or other output devices. The user interface 114 may include input devices that receive information (e.g., commands) from one or more users. By way of example, the user interface 114 may include buttons, switches, knobs, touchscreens, microphones, or other input devices.

The lifting implement 50 and/or the cart implement 60 may include one or more actuators 116 that facilitate controlled movement (e.g., movement of the lifting implement 50 or the cart implement 60). The actuators 116 may include linear actuators (e.g., electric linear actuators, hydraulic cylinders, etc.), motors (e.g., electric motors, hydraulic motors, etc.), or other types of actuators. The actuators 116 may be electrically-powered, hydraulically-powered, or otherwise powered.

The lifting implement 50 and/or the cart implement 60 may include a hydraulic system 120. They hydraulic system 120 may supply pressurized hydraulic fluid (e.g., hydraulic oil) to facilitate operation of other components of the vehicle 10. By way of example, the hydraulic system 120 may supply pressurized hydraulic fluid to an actuator 116. In some embodiments, the hydraulic system 120 forms a self-contained hydraulic loop with one or more actuators 116.

The hydraulic system 120 includes a low-pressure reservoir, shown as tank 122, that stores a volume of hydraulic fluid at a low pressure. A pump 124 receives electrical energy from the batteries 110, draws hydraulic fluid from the tank 122, and supplies a flow of pressurized hydraulic fluid. One or more valves 126 (e.g., solenoid valves, directional control valves, etc.) control the flow of the hydraulic fluid from the pump 124. By way of example, the valves 126 may control the flow rate, direction, and destination of hydraulic fluid flowing throughout the hydraulic system 120. The controller 102 may control operation of the actuators 116 by controlling the valves 126.

The control system 100 further includes additional devices in communication with the vehicle 10. The devices may communicate with the vehicle 10 directly or through a network 130 (e.g., a local area network, a wide area network, the Internet, etc.). The network 130 may utilize wireless and/or wired communication. In some embodiments, the network 130 is a mesh network formed between multiple devices of the control system 100 (e.g., permitting indirect communication between two devices through a third device).

The control system 100 may include multiple vehicles 10. A vehicle 10 may communicate with other vehicles 10 to share information and facilitate operation. By way of example, a vehicle 10 may provide commands to another vehicle 10 to coordinate transportation of a large item that is carried by both of the vehicles 10. By way of another example, a vehicle 10 may provide its location to another vehicle 10 to facilitate path generation and avoid collisions.

The control system 100 may include one or more user devices 132 (e.g., smartphones, tablets, laptops, desktop computers, etc.). The user devices 132 may facilitate a user monitoring and/or controlling operation of the vehicles 10. By way of example, the user devices 132 may indicate statuses of the vehicles 10 (e.g., positions, whether maintenance is needed, if any errors are occurring, what task a vehicle 10 is assigned, etc.). By way of example, the user devices 132 may permit a user to command a vehicle 10 to travel to a different place or to assign a vehicle 10 to a particular production line.

The control system may include one or more remote devices 134 (e.g., servers). In some embodiments, a remote device 134 functions as a production manager that controls various operations throughout a manufacturing environment. The production manager may receive requests for production of certain equipment (e.g., fifteen telehandlers are requested for production by Apr. 12, 2025, etc.). The production manager may monitor the statuses of vehicles 10, personnel, equipment, and raw materials. By way of example, the vehicles 10 may provide sensor data from the sensors 112 to a remote device 134 for storage and/or analysis. Based on the available data, the production manager may generate assignments for vehicles 10, personnel, equipment, and raw materials to meet the production requests. The production manager may adapt to changes in availability (e.g., by reassigning a vehicle 10 to a different task or area in response to a failure of one of the vehicles 10). The assignments for a vehicle 10 may include a path along which the vehicle 10 should travel, a desired configuration of the vehicle 10 (e.g., the type of implement available to the vehicle 10), an amount of time that the vehicle 10 should wait at a given station, etc.

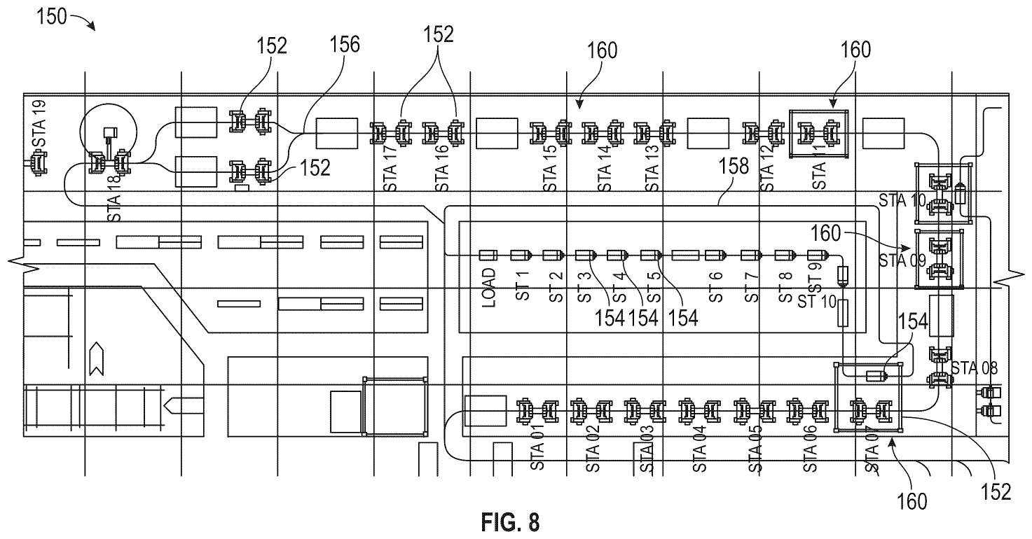

Referring to FIG. 8, a manufacturing environment or production system 150 is shown according to an exemplary embodiment. The production system 150 may include a series of vehicles 10 that move a product 152 and a subassembly 154 through various stages of assembly (e.g., as controlled by a remote device 134). The vehicles 10 move the product 152 along a first path, shown as manufacturing line 156, and the vehicles 10 move the subassembly 154 along a second path, shown as manufacturing line 158. A series of manufacturing or assembly stations, shown as stations 160, are spaced at regular intervals along the manufacturing lines 156 and 158. Each station 160 may be associated with a different manufacturing or assembly process that is performed there. By way of example, there may be stations 160 for attaching components to a product 152, coupling components with hoses or wires, confirming that certain functions are operating properly, etc.

Initially the product 152 and the subassembly 154 move along separate manufacturing lines 156 and 158. After the last station 160 needed to prepare the subassembly 154, the manufacturing line 158 intersects the manufacturing line 156, and the subassembly 154 is attached to the product 152. The product 152 and the subassembly 154 then move together along the manufacturing line 156. This proceeds until the product 152 is fully assembled and removed from the vehicles 10. The vehicles 10 may then return to collect another product that requires assembly, and the manufacturing process is repeated.

In some embodiments, the product 152 assembled by the production system is a vehicle or work machine. By way of example, the product 152 may be a lift device, such as a telehandler, a scissor lift, a boom lift, a vertical lift, an aerial work platform, or another type of lift device. By way of another example, the product 152 may be a fire truck, an aircraft rescue and firefighting apparatus (ARFF) truck, a refuse vehicle, a concrete mixing truck, a tow truck, a broadcast van, a military vehicle, a robot, a truck, a van, a passenger vehicle, or another type of vehicle. In other embodiments, the product 152 is not a vehicle (e.g., is a stationary piece of equipment).

### Vehicle Coupling System

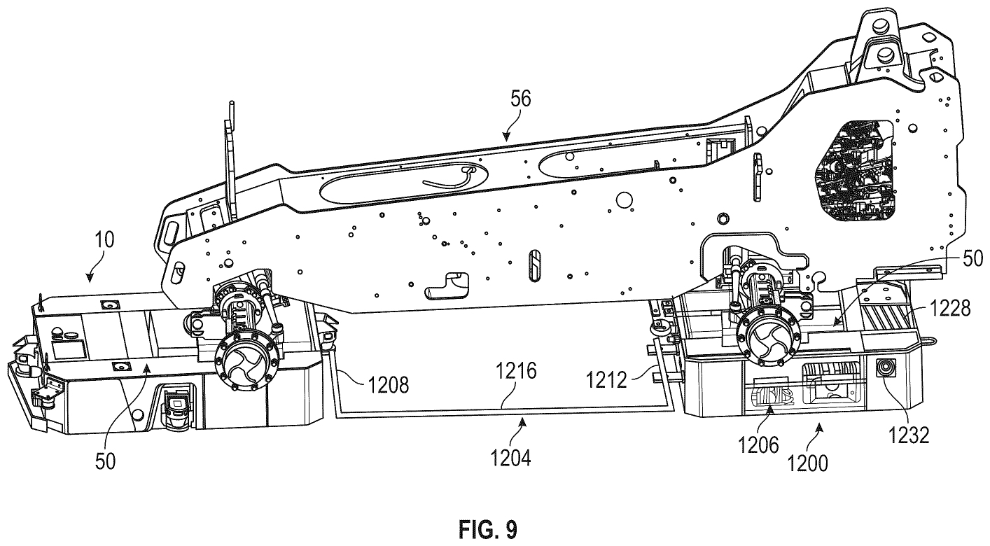

Referring to FIG. 9, the vehicle 10 is utilized with a second vehicle (e.g., cart), shown as skate 1200, to support a product such as the telehandler 56. The vehicle 10 and the skate 1200 may cooperatively operate to facilitate steering the product and distributing the weight of the product during transportation. The skate 1200 may be substantially similar to the vehicle 10 except as otherwise specified herein.

According to an exemplary embodiment, the skate 1200 omits the drive motors 42 and is instead propelled and steered by the vehicle 10. The skate 1200 and the vehicle 10 may be mechanically coupled to each other by a mechanical linkage (e.g., tube, bar, coupler, etc.), shown as tow bar 1204, extending therebetween to maintain a distance between the skate 1200 and the vehicle 10 (e.g., as the vehicle 10 travels). The tow bar 1204 may be pivotably coupled to the vehicle 10 (e.g., by a pivot joint, by a pin about which the tow bar 1204 can pivot, etc.) and fixedly coupled to the skate 1200 such that when the drive motors 42 of the vehicle 10 provide rotational mechanical energy to drive the tractive elements 44 and propel the vehicle 10, the tow bar 1204 pulls the skate 1200 with the vehicle 10. In this manner, responsive to the vehicle 10 being driven, the tow bar 1204 exerts a force on the skate 1200 such that the skate 1200 is driven at the same speed, in the same direction, and is maintained at a fixed distance (e.g., the fixed distance being a length of the tow bar 1204) from the vehicle 10 (e.g., even if the vehicle 10 and the skate 1200 are not collectively supporting the product). By way of example, when the vehicle 10 turns, the tow bar 1204 pivots relative to the vehicle 10 and exerts a force on the skate 1200 to pull the skate 1200 such that the skate 1200 trails the vehicle 10.

Referring still to FIG. 9, the cradle 52 of the vehicle 10 may be configured to pivot relative to the frame 12. By way of example, when the vehicle 10 turns and the cradle 52 is supporting the product, the cradle 52 can pivot relative to the frame 12. In such examples, the maximum angle at which cradle 52 can pivot relative to the frame 12 may be limited (e.g., by a pin contacting a mechanical stop). In some embodiments, the cradle 52 included in the skate 1200 is fixed relative to the frame thereof (e.g., rotation of the cradle 52 relative to the frame of the skate 1200 is inhibited). The frame of the skate 1200 and various components coupled to the frame form a base portion of the skate 1200, shown as base assembly 1206.

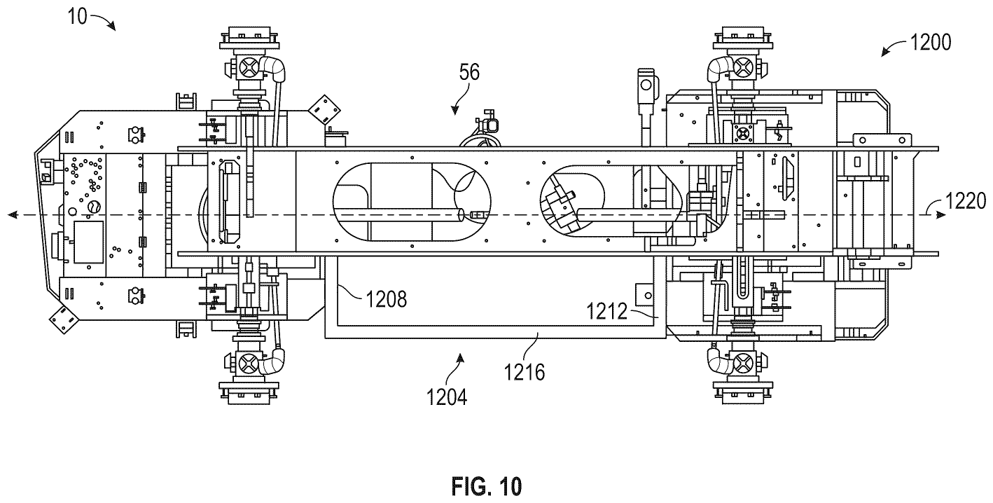

Referring to FIGS. 9 and 10, the tow bar 1204 includes one or more straight or bent sections. As shown in FIGS. 9 and 10, the tow bar 1204 includes a first portion, shown as first lateral section 1208, configured to pivotably couple with the vehicle 10; a second portion, shown as second lateral section 1212, configured to fixedly couple with the skate 1200; and a third portion (e.g., intermediate portion, middle portion, etc.), shown as longitudinal section 1216, extending between the first lateral section 1208 and the second lateral section 1212. The first lateral section 1208 may be pivotably coupled with the vehicle 10 at a pivot (e.g., mounting location, joint, coupler, hitch, ball joint, etc.) substantially centered in a lateral direction along the back plate 18 (e.g., the rear surface 34) and extend in a lateral direction away from the pivot. In some embodiments, the first lateral section 1208 is otherwise coupled with the vehicle 10 (e.g., at another suitable location, using another suitable coupling mechanism, etc.). The second lateral section 1212 may be fixedly coupled with the skate 1200 at a mounting location (e.g., fixation point) substantially centered in a lateral direction along a front plate (e.g., front surface 32) of the skate 1200 and extend in a lateral direction away from the mounting location. In some embodiments, the second lateral section 1212 is otherwise coupled with the skate 1200 (e.g., at another suitable location, using another suitable coupling mechanism, etc.). AS shown in FIGS. 9 and 10, the longitudinal section 1216 couples and extends between the first lateral section 1208 and the second lateral section 1212. In such a configuration, the longitudinal section 1216 is laterally offset from an axis (e.g., a lateral center axis, an axis extending in a longitudinal direction and centered in a lateral direction, etc.), shown as center axis 1220, of the product, the vehicle 10, the skate 1200, etc., such the tow bar 1204 generally defines a U-shape. With the longitudinal section 1216 offset from the center axis 1220 of the product, the vehicle 10, the skate 1200, etc., the section of the product between the vehicle 10 and the skate 1200 is more easily accessible to perform a manufacturing, assembly, testing, or other process thereon. By way of example, when the product is the telehandler 56, with the longitudinal section 1216 offset from the center axis 1220, the bottom surface of the telehandler 56 is more easily accessible to assemble one or more components of the telehandler 56 such as a driveshaft, hoses, wires, etc. In other embodiments, the tow bar 1204 does not include the first and second lateral sections 1208, 1212, and the longitudinal section 1216 extends directly between the vehicle 10 and the skate 1200 and is offset from the center axis 1220.

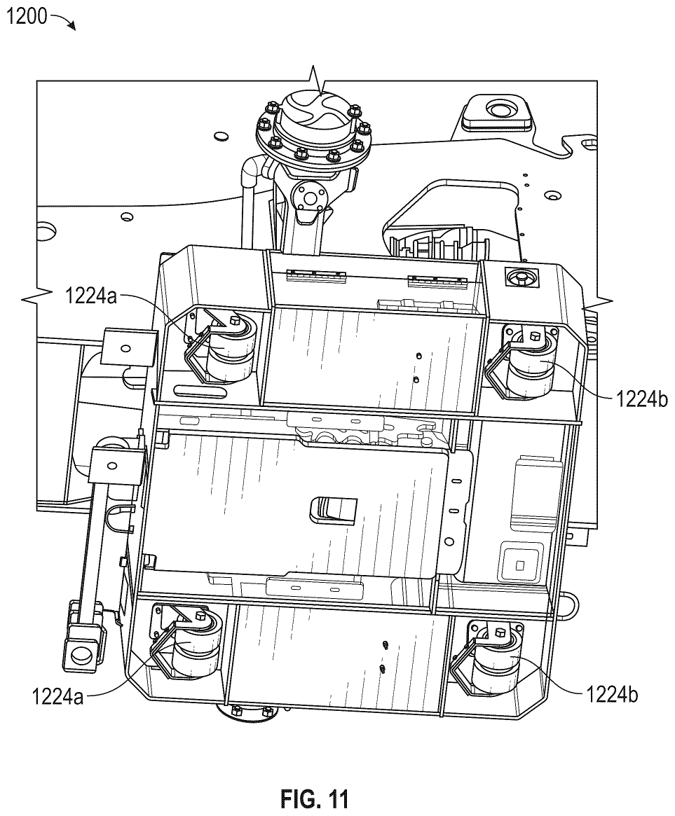

Referring to FIG. 11, the skate 1200 includes one or more tractive elements, shown as casters 1224, to facilitate movement of the skate 1200 along a ground surface. By way of example, when the skate 1200 is pulled by the tow bar 1204 when the vehicle 10 is propelled, the casters 1224 support the weight of the skate 1200 and facilitate movement of the skate 1200. In some embodiments, the casters 1224 positioned proximate a front surface of the skate 1200 are swivel casters 1224a that are capable of freely rotating about a vertical axis. By way of example, when the vehicle 10 and the skate 1200 are turning, the swivel casters 1224a can rotate about a vertical axis to facilitate free movement of the skate 1200. In some embodiments, the casters 1224 positioned proximate a rear surface (e.g., rear surface 34) of the skate 1200 are fixed casters 1224b that are fixed relative to a vertical axis (e.g., the fixed casters 1224b are unable to rotate about the vertical axis). In other embodiments, each caster 1224 of the skate 1200 is a swivel caster 1224a. In yet other embodiments, each caster 1224 of the skate 1200 is a fixed caster 1224b.

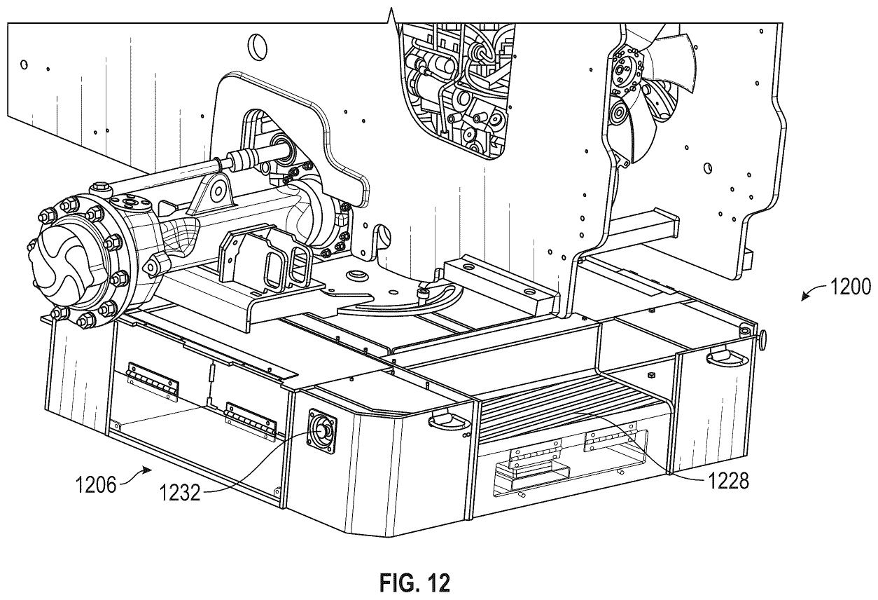

Referring to FIG. 12, the skate 1200 includes a support surface, shown as step 1228, extending in a substantially horizontal plane (e.g., a plane substantially parallel to the ground surface) and provides a surface onto which a user can step. In some embodiments, the step 1228 is positioned proximate the rear surface of the skate 1200 between the lateral side surfaces. In other embodiments, the skate 1200 includes one or more steps 1228 variously positioned about the skate 1200.

Referring still to FIG. 12, the skate 1200 includes one or more operator interface elements (e.g., input devices, output devices, etc.), shown as user interface 1232. As shown in FIG. 12, the user interface 1232 is configured as an emergency stop button. The emergency stop button may be engaged by a user to manually override one or more operations of the vehicle 10, the skate 1200, and/or any one or more components included therein. In some embodiments, the user interface 1232 may include buttons, switches, knobs, touchscreens, microphones, or other input devices that receive information (e.g., commands) from one or more users. In some embodiments, the user interface 1232 may include displays, speakers, lights, haptic feedback (e.g., vibrators, etc.), or other output devices that provide information to one or more users.

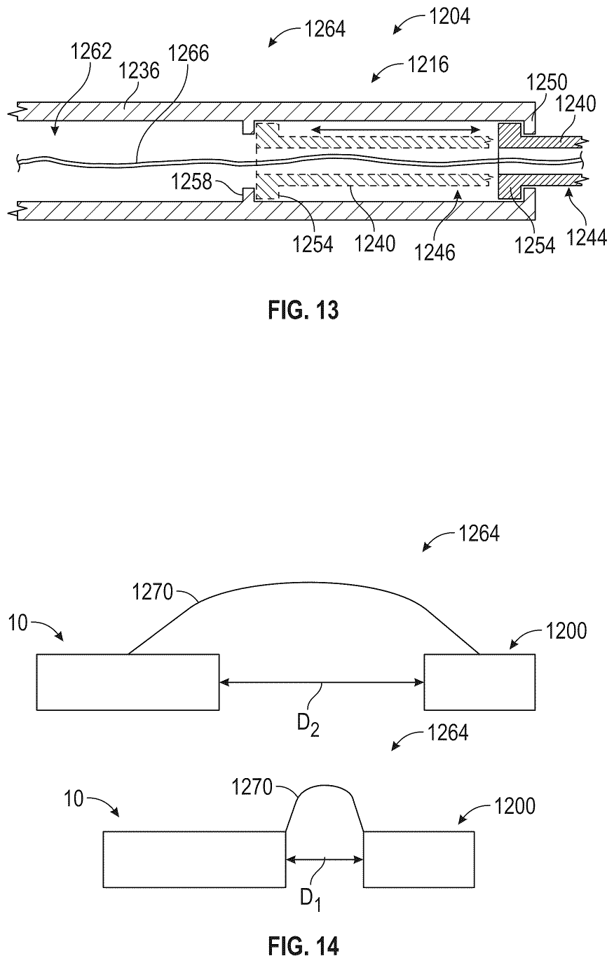

Referring to FIG. 13, the longitudinal section 1216 may include a telescoping section configured to facilitate varying a length of the tow bar 1204. Varying the length of the tow bar 1204 enables the vehicle 10 and the skate 1200 to support or otherwise accommodate for products having different lengths. The longitudinal section 1216 includes an outer telescoping portion (e.g., an outer casing), shown as first telescoping section 1236, and an inner telescoping portion, shown as second telescoping section 1240. The first telescoping section 1236 is configured to receive at least a portion of the second telescoping section 1240 (e.g., at least a portion of the second telescoping section 1240 is nested within the first telescoping section 1236). The first telescoping section 1236 and the second telescoping section 1240 are slidable relative to each other to facilitate varying the length of the longitudinal section 1216. In other words, the first telescoping section 1236 and the second telescoping section 1240 are telescopically coupled to each other to accommodate for a change in the distance between the vehicle 10 and the skate 1200. As shown by the direction of the arrows in FIG. 13, the second telescoping section 1240 may translate within the first telescoping section 1236 to transition the tow bar 1204 between a first, extended position, shown as lengthened position 1244 and a second, retracted position, shown as shortened position 1246. In the lengthened position 1244, the tow bar 1204 is fully extended to a maximum length (e.g., a maximum distance between the vehicle 10 and the skate 1200). In the shortened position 1246, the tow bar 1204 is shortened to a minimum length (e.g., a minimum distance between the vehicle 10 and the skate 1200).

The first telescoping section 1236 includes a flange 1250 configured to engage with a shoulder 1254 of the second telescoping section 1240 to prevent translation of the shoulder 1254 beyond the flange 1250, thereby maintaining the second telescoping section 1240 within the first telescoping section 1236. By way of example, when the tow bar 1204 is in the lengthened position 1244, the flange 1250 may engage with the shoulder 1254 to prevent translation of the shoulder 1254 past the flange 1250. Similarly, the first telescoping section 1236 includes a flange 1258 configured to engage with the shoulder 1254 of the second telescoping section 1240 to prevent translation of the shoulder 1254 past the flange 1258, thereby maintaining the second telescoping section 1240 within the first telescoping section 1236. By way of example, when the tow bar 1204 is in the shortened position 1246, the flange 1258 may engage with the shoulder 1254 to prevent translation of the shoulder 1254 past the flange 1258.

Referring still to FIG. 13, vehicle 10 and the skate 1200 use a conduit management system 1264 to facilitate coupling the vehicle 10 and the skate 1200 together with a conduit 1266 (e.g., tether, tube, hose, etc.). According to an exemplary embodiment, the conduit management system 1264 may be or include the tow bar 1204 (e.g., the first lateral section 1208, the second lateral section 1212, and the longitudinal section 1216) defining an interior cavity 1262. In some embodiments, the conduit 1266 is configured to be routed from the vehicle 10 to the skate 1200 through the tow bar 1204 via the interior cavity 1262. The conduit 1266 is configured to facilitate transferring at least one of (i) electrical energy, (ii) fluid power, or (iii) information between the vehicle 10 and the skate 1200. The tow bar 1204 may support a portion of the conduit 1266 extending between and coupling the vehicle 10 with the skate 1200 (e.g., support the conduit 1266 extending across the space defined by the distance between the vehicle 10 and the skate 1200).

In some embodiments, the conduit 1266 is or includes an electrical energy transfer conduit (e.g., wire, cable, etc.) configured to transfer electrical energy between the vehicle 10 and the skate 1200. In such embodiments, the conduit 1266 electrically couples an electrical energy source of the vehicle 10 (e.g., the batteries 110) with the skate 1200 to facilitate delivering electrical energy to one or more components thereof and power the same. By way of example, the conduit 1266 may be configured to deliver electrical energy from the batteries 110 of the vehicle 10 to power a control system (e.g., control system 1300) of the skate 1200, the user interface 1232, the actuators 116 of the lifting implement 50 included in the skate 1200 (e.g., in an embodiment where the actuators 116 are electrically powered), or other components of the skate 1200.

In some embodiments, the conduit 1266 is or includes a fluid transfer conduit (e.g., hose, pipe, tube, hydraulic fluid line, pneumatic fluid line, etc.) configured to transfer fluid power between the vehicle 10 and the skate 1200. In such embodiments, the conduit 1266 fluidly couples a fluid supply source of the vehicle 10 (e.g., the hydraulic system 120, a pneumatic pump, etc.) with the skate 1200 to facilitate delivering fluid power to one or more components thereof. By way of example, the conduit 1266 may be configured to supply pressurized hydraulic fluid from the hydraulic system 120 of the vehicle 10 to the hydraulic system 120 of the skate 1200 to fluidly power the actuators 116 of the lifting implement 50 included in the skate 1200 (e.g., in an embodiment where the actuators 116 are hydraulically powered) or other components of the skate 1200.

In some embodiments, the conduit 1266 is or includes a data transfer conduit (e.g., wire, cables, CAN, Ethernet, etc.) configured to transfer data between the vehicle 10 and the skate 1200. In such embodiments, the conduit 1266 is a wired connection that communicably couples the control system 100 of the vehicle 10 with skate 1200 to facilitate transmitting information to the skate 1200 to control operation thereof. By way of example, the control system 100 of the vehicle 10 can transmit control signals to a control system (e.g., control system 1300) of the skate 1200 and/or directly to one or more components of the skate 1200 via the conduit 1266 to control operation thereof. Additionally or alternatively, the communication interface 108 may facilitate wireless communication (e.g., through Bluetooth, Wi-Fi, radio transmission, inductive transmission of energy, etc.) between the vehicle 10 and the skate 1200. By way of another example, the control system of the skate 1200 can transmit control signals and/or other information associated with the operation of thereof to the vehicle 10 via the conduit 1266 and/or wirelessly via communications established between a communication interface (e.g., communication interface 1308) of the skate 1200 and the communication interface 108 of the vehicle 10.

Referring to FIG. 14, in addition to or as an alternative to the conduit 1266 coupling (e.g., electrically coupling, fluidly coupling, and/or communicably coupling) the vehicle 10 with the skate 1200 via the interior cavity 1262 of the tow bar 1204, the conduit management system 1264 may be or include a flexible rod (e.g., flexible member, deformable member, etc.), shown as conduit rod 1270, configured to support the conduit 1266 to facilitate routing the conduit 1266 between the vehicle 10 and the skate 1200. As shown in FIG. 14, the conduit rod 1270 may be configured to couple to the vehicle 10 and the skate 1200. The conduit rod 1270 may be configured to deform (e.g., bend, arc, curl, etc.) when the vehicle 10 and the skate 1200 are brought closer together. By way of example, when the vehicle 10 and the skate 1200 are spaced by a distance D₁ that is shorter than a distance D2, the conduit rod 1270 deforms to accommodate for the change in distance while remaining coupled to each of the vehicle 10 and the skate 1200. The conduit rod 1270 may be manufactured from one or more sections of straight or bent sections. The conduit rod 1270 may be manufactured from a material such as fiberglass or another suitable material capable of withstanding repeated deformation. The conduit rod 1270 may include an interior cavity configured to receive the conduit 1266 and support a portion of the conduit 1266 extending between and coupling the vehicle 10 with the skate 1200 (e.g., support the conduit 1266 extending across the space defined by the distance between the vehicle 10 and the skate 1200).

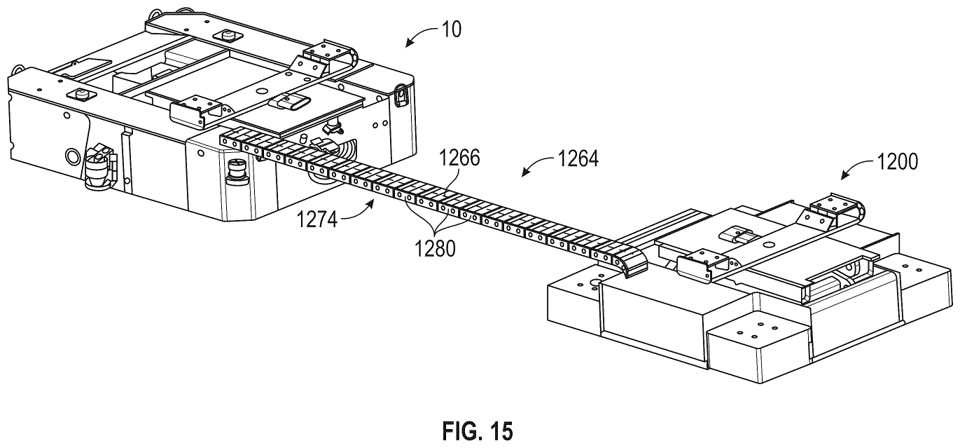

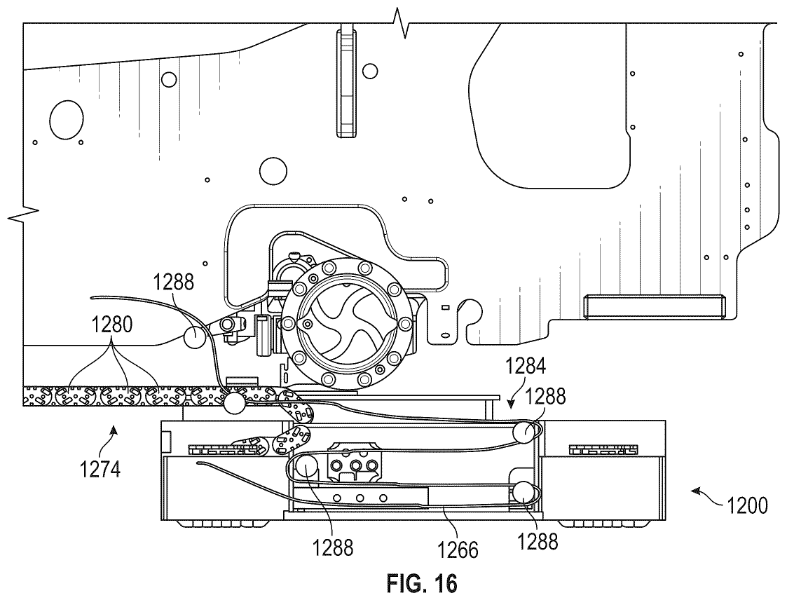

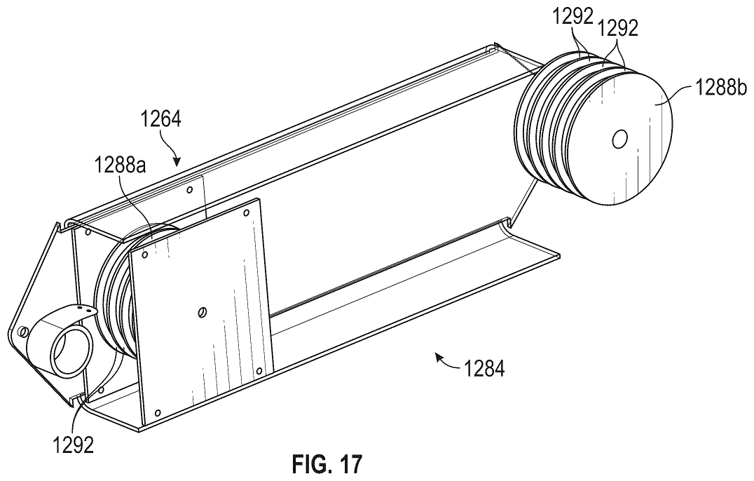

Referring to FIGS. 15 and 16, in addition to or as an alternative to the conduit 1266 coupling the vehicle 10 with the skate 1200 via the interior cavity 1262 of the tow bar 1204, the conduit management system 1264 may be or include a power track (e.g., cable guide, cable support linkage, etc.), shown as conduit track 1274, to facilitate routing the conduit 1266 between the vehicle 10 and the skate 1200. The conduit track 1274 may be a flexible chain configured to couple to the vehicle 10 at a first end and coupled to the skate 1200 at a second end opposite the first end. The conduit track 1274 may include a plurality of links 1280 pivotably linked together such that the conduit track 1274 can bend and flex. The links 1280 may be arranged in series (i.e., in a chain) and may be rotatable with respect to adjacent links 1280. In some embodiments, the links 1280 are rotatable in only a first direction of rotation relative to adjacent links 1280. This rotation may cause conduit track 1274 to bend or fold in a predictable manner (e.g., in a predictable direction, at a predictable angle, etc.). By way of example, as shown in FIG. 16, the second end of the conduit track 1274 is coupled to the skate 1200 and the conduit track 1274 is configured to bend and roll along a top surface of the skate 1200 to accommodate for a change in distance between the skate 1200 and the vehicle 10. In some embodiments, when the conduit track 1274 is fully extended, no portion of the conduit track 1274 is rolled along the top surface of the skate 1200, and as the vehicle 10 and the skate 1200 come closer together, at least a portion of the conduit track 1274 bends and rolls along the top surface of the skate 1200 (as shown in FIG. 16). The conduit track 1274 may be configured to accommodate (e.g., receive, contain, etc.) the conduit 1266 to support a portion of the conduit 1266 extending between and coupling the vehicle 10 with the skate 1200 (e.g., support the conduit 1266 extending across the space defined by the distance between the vehicle 10 and the skate 1200), thereby providing a flexible and protected path for the conduit 1266 accommodated therein. In some embodiments, the conduit track 1274 is configured to bend and roll along a top surface 30 of the vehicle 10 to accommodate for a change in distance between the skate 1200 and the vehicle 10.

Referring to FIGS. 16 and 17, the conduit management system 1264 may be or include a pulley system 1284 to facilitate letting out the conduit 1266 and taking up the conduit 1266 as the distance between the vehicle 10 and the skate 1200 changes. As shown, the pulley system 1284 includes a plurality of pulleys 1288 each including one or more journals 1292 (e.g., cable supports, cable tracks, etc.) configured to receive at least a portion of the conduit 1266 and retain the portion of the conduit 1266 (e.g., during take-up and let-out of the conduit 1266). The pulley system 1284 can facilitate routing the conduit 1266 in a compact and organized manner. The pulleys 1288 may be positioned and oriented to control the direction in which the conduit 1266 is routed (e.g., to supply the conduit 1266 to a desired location, to route the conduit 1266 to avoid one or more obstacles, etc.).

Referring to FIG. 17, the pulley system 1284 may include a fixed pulley 1288a and a translatable pulley 1288b configured to translate relative to the fixed pulley 1288a. The translatable pulley 1288b may be biased (e.g., spring biased) in a direction away from the fixed pulley 1288a. Each of the fixed pulley 1288a and the translatable pulley 1288b are shown to include four journals 1292. In some embodiments, the pulleys 1288 include more or fewer than four journals 1292. The journals 1292 may be configured to receive the conduit 1266 such that the conduit 1266 is routed (e.g., snaked) between the fixed pulley 1288a and the translatable pulley 1288b. When the distance between the vehicle 10 and the skate 1200 is increased, the pulley system 1284 may let-out a section of the conduit 1266 to accommodate for the increased distance. The translatable pulley 1288b may overcome the bias and translate in a direction towards the fixed pulley 1288a to let-out the conduit 1266 received in the journals 1292. The number of the journals 1292 included in the fixed pulley 1288a and the translatable pulley 1288b (and about which the conduit 1266 is routed) is correlated with the length of conduit 1266 let-out therefrom. By way of example, with four journals 1292 each, the amount of conduit 1266 that is let-out may be eight times greater than the amount that the translatable pulley 1288b translates. In other words, with four journals 1292 each, for every inch of translation of the translatable pulley 1288b in a direction towards the fixed pulley 1288a, eight inches of conduit 1266 may be let-out from the pulley system 1284. When the distance between the vehicle 10 and the skate 1200 is decreased, the pulley system 1284 may take-up a section of the conduit 1266 to accommodate for the decreased distance. By way of example, the translatable pulley 1288b may translate in a direction away from the fixed pulley 1288a (e.g., due to being biased away from the fixed pulley 1288a) to take-up the conduit 1266.

In some embodiments, the when the vehicle 10 and the skate 1200 are cooperatively operating to facilitate steering the product and distributing the weight of the product during transportation, the conduit 1266 may be routed between the vehicle 10 and the skate 1200 along the product. By way of example, at least a portion of the section of the conduit 1266 extending between the vehicle 10 and the skate 1200 may be coupled to the product (e.g., by one or more hooks, adhesives, fasteners, channels, tip-ties, etc.). By way of another example, the conduit 1266 may be supported by (e.g., rest on, couple with, etc.) one or more components of the product (e.g., a frame of the telehandler 56).

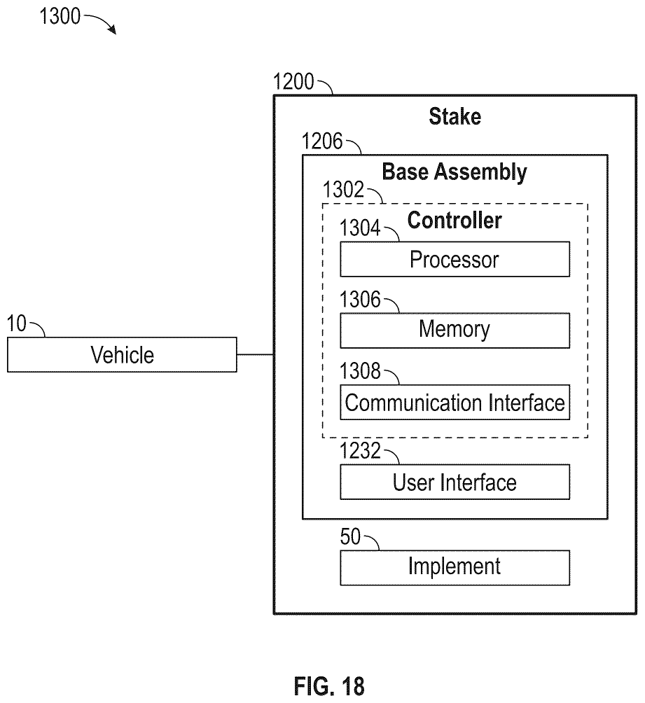

Referring to FIG. 18, the skate 1200 and a control system 1300 for the skate 1200 are shown according to an exemplary embodiment. The control system 1300 may facilitate operation of the skate 1200 and/or other devices of a production environment. The skate 1200 may include a controller 1302 that controls operation of the skate 1200. The controller 1302 includes a processing circuit, shown as processor 1304, and a memory device, shown as memory 1306. The memory 1306 may contain one or more instructions that, when executed by the processor 1304, cause the processor to perform the various functions described herein. The controller 1302 further includes a communication interface 1308 (e.g., a communication circuit, a network interface, etc.) that facilitates communication with (e.g., to and from) other components of the skate 1200 and/or the control system 1300. The communication interface 1308 may facilitate wired communication (e.g., via the conduit 1266, through CAN, Ethernet, communication of power, etc.). Additionally or alternatively, the communication interface 1308 may facilitate wireless communication (e.g., through Bluetooth, Wi-Fi, radio transmission, inductive transmission of energy, etc.).

The base assembly 1206 may include one or more user interfaces 1232. The user interface 1232 may be configured as an emergency stop button that can be engaged by a user to manually override one or more operations of the vehicle 10, the skate 1200, and/or any one or more components included therein. As described in greater detail above, the user interface 1232 may include one or more other operator interface elements (e.g., input devices, output devices, etc.).

The skate 1200 includes the implement 50 configured to receive and directly support a product and raise or lower the product. The controller 1302 may control operation of the implement 50 and the components thereof.

The control system 1300 may include the vehicle 10 and the skate 1200. The vehicle 10 and the skate 1200 may be coupled (e.g., electrically coupled, fluidly coupled, and/or communicably coupled) to each other via the conduit 1266. The controller 1302 of the skate 1200 may control the transfer of electrical energy, the transfer of fluid power, and/or the transfer of data between the vehicle 10 and the skate 1200. By way of example, responsive to a signal received from the controller 1302 of the skate 1200, the vehicle 10 may (i) transfer electrical energy from the batteries 110 of the vehicle 10 to power one or more components of the skate 1200, (ii) transfer fluid power from the hydraulic system 120 to fluidly power one or more components of the skate 1200, and/or (iii) transfer data associated with the operation of the vehicle 10 to the skate 1200 (e.g., to control one or more components of the skate 1200) via the conduit 1266. In some embodiments, the skate 1200 transmits data associated with the operation thereof to the vehicle 10 (e.g., wirelessly via the communication interface 1308 and/or via a wired connection). Responsive to the data, the controller 102 of the vehicle 10 may determine whether to transfer electrical energy, fluid power, and/or data to the skate 1200. In some embodiments, the controller 102 is communicably coupled with the skate 1200 to control operation of the components thereof. In such an embodiment, the skate 1200 does not include the controller 1302 and operational control and processing is performed remote from the skate 1200 (e.g., by the controller 102, by a remote server, etc.).

In some embodiments, the skate 1200 includes one or more sensors (e.g., sensors 112) operatively coupled to the controller 1302 and/or the controller 102. The sensors may provide sensor data indicative of the current status of the vehicle 10, the skate 1200, and/or the surrounding environment. In such embodiments, vehicle 10 may communicate with the skate 1200 to share information and facilitate operation. By way of example, the vehicle 10 may provide commands to the skate 1200 to coordinate transportation of a large item that is carried by both the vehicle 10 and the skate 1200. By way of another example, the vehicle 10 may provide its location to the skate 1200 to facilitate path generation and avoid collisions. In such embodiments, the skate 1200 may include one or more drive motors (e.g., drive motors 42) to provide rotational mechanical energy to drive rotation of one or more tractive elements and propel the skate 1200 to maintain a fixed distance from the vehicle 10 without the use of the tow bar 1204.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the skate 1200, and the production system as shown in the various exemplary embodiments is illustrative only. Additionally, any element disclosed in one embodiment may be incorporated or utilized with any other embodiment disclosed herein. For example, the conduit management system 1264 of the exemplary embodiment shown in at least FIG. 13 may be incorporated in the conduit management system 1264 of the exemplary embodiment shown in at least FIG. 15. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A vehicle coupling system comprising:
a first vehicle including:
a chassis;
a plurality of tractive elements coupled to the chassis, the plurality of tractive elements configured to engage a ground surface to support the first vehicle;
a drive motor configured to drive one or more of the plurality of tractive elements to propel the first vehicle; and
a lifting implement configured to support a product for movement via the drive motor;
a second vehicle including:
a chassis;
a plurality of tractive elements coupled to the chassis, the plurality of tractive elements configured to engage the ground surface to support the second vehicle; and
a lifting implement configured to support the product for movement; and
a tow bar coupled to the first vehicle at a first end of the tow bar and coupled to the second vehicle at a second end of the tow bar opposite the first end;
wherein, responsive to the drive motor propelling the first vehicle, the tow bar exerts a force on the second vehicle to maintain a space between the second vehicle and the first vehicle.

2. The vehicle coupling system of claim 1, wherein the tow bar is pivotably coupled to the first vehicle at the first end of the tow bar.

3. The vehicle coupling system of claim 1, wherein the tow bar includes two or more members telescopically coupled to each other to accommodate for a change in a distance of the space between the second vehicle and the first vehicle.

4. The vehicle coupling system of claim 3, wherein a first member of the two or more members includes a first flange configured to prevent translation of a second member of the two or more members in a first direction, and a second flange configured to prevent translation of the second member in a second direction opposite the first direction.

5. The vehicle coupling system of claim 1, wherein the tow bar includes a first portion coupled to the first vehicle, a second portion coupled to the second vehicle, and a third portion extending between the first portion and the second portion.

6. The vehicle coupling system of claim 5, wherein the third portion is laterally offset from a lateral center axis of the first vehicle and the second vehicle.

7. The vehicle coupling system of claim 1, further comprising a conduit coupling the first vehicle with the second vehicle, the conduit configured to transfer at least one of (i) electrical energy, (ii) fluid power, or (iii) information between the first vehicle and the second vehicle.

8. The vehicle coupling system of claim 7, wherein the tow bar defines an interior cavity configured to receive a portion of the conduit extending between the first vehicle and the second vehicle.

9. The vehicle coupling system of claim 7, further comprising a flexible member configured to deform to accommodate for a change in a distance of the space between the second vehicle and the first vehicle, wherein the flexible member is configured to support a portion of the conduit extending between the first vehicle and the second vehicle.

10. The vehicle coupling system of claim 7, further comprising a track including a plurality of links, wherein each link of the plurality of links is rotatably coupled to an adjacent link, wherein the track is configured to roll along a top surface of the first vehicle or the second vehicle to accommodate for a change in a distance of the space between the second vehicle and the first vehicle, and wherein the track is configured to support a portion of the conduit extending between the first vehicle and the second vehicle.

11. The vehicle coupling system of claim 7, further comprising a pulley system configured to receive the conduit, and let out and take up the conduit to accommodate for a change in a distance of the space between the second vehicle and the first vehicle.

12. The vehicle coupling system of claim 11, wherein the pulley system includes a first pulley and a second pulley each configured to receive the conduit, wherein the second pulley is translatable relative to the first pulley and biased in a direction away from the first pulley, wherein, when the distance of the space between the second vehicle and the first vehicle increases, the pulley system lets out the conduit, and wherein, when the distance of the space between the second vehicle and the first vehicle decreases, the second pulley is biased to translate in the direction away from the first pulley to take up the conduit.

13. The vehicle coupling system of claim 1, further comprising one or more processing circuits configured to:
acquire sensor data regarding an area surrounding the first vehicle; and
control the first vehicle to autonomously navigate throughout the area based on the sensor data.

14. The vehicle coupling system of claim 1, wherein the second vehicle includes a user interface configured to receive an input, and wherein the vehicle coupling system further comprises one or more processing circuits configured to control the first vehicle based on the input.

15. A vehicle coupling system comprising:
a first vehicle including:
a chassis;
a plurality of tractive elements coupled to the chassis, the plurality of tractive elements configured to engage a ground surface to support the first vehicle;
a drive motor configured to drive one or more of the plurality of tractive elements to propel the first vehicle; and
a lifting implement configured to support a product for movement via the drive motor;
a second vehicle including:
a chassis;
a plurality of tractive elements coupled to the chassis, the plurality of tractive elements configured to engage the ground surface to support the second vehicle; and
a lifting implement configured to support the product for movement; and
a conduit coupling the first vehicle with the second vehicle, the conduit configured to transfer at least one of (i) electrical energy, (ii) fluid power, or (iii) information between the first vehicle and the second vehicle; and
a conduit management system configured to support a portion the conduit extending across a space defined by a distance between the first vehicle and the second vehicle.

16. The vehicle coupling system of claim 15, wherein the conduit management system includes a tow bar coupled to the first vehicle at a first end of the tow bar and coupled to the second vehicle at a second end of the tow bar opposite the first end, wherein, responsive to the drive motor propelling the first vehicle, the tow bar exerts a force on the second vehicle to maintain the space between the second vehicle and the first vehicle, and wherein the tow bar defines an interior cavity configured to receive the portion of the conduit extending between the first vehicle and the second vehicle.

17. The vehicle coupling system of claim 15, wherein the conduit management system includes a flexible member configured to deform to accommodate for a change in the distance between the second vehicle and the first vehicle, wherein the flexible member is configured to support the portion of the conduit extending between the first vehicle and the second vehicle.

18. The vehicle coupling system of claim 15, wherein the conduit management system includes a track including a plurality of links, wherein each link of the plurality of links is rotatably coupled to an adjacent link, wherein the track is configured to roll along a top surface of the first vehicle or the second vehicle to accommodate for a change in the distance between the second vehicle and the first vehicle, and wherein the track is configured to support the portion of the conduit extending between the first vehicle and the second vehicle.

19. The vehicle coupling system of claim 15, wherein the conduit management system includes a pulley system configured to receive the conduit, and let out and take up the conduit to accommodate for a change in the distance between the second vehicle and the first vehicle.

20. A vehicle coupling system comprising:
a first vehicle including:
a chassis;
a plurality of tractive elements coupled to the chassis, the plurality of tractive elements configured to engage a ground surface to support the first vehicle;
a drive motor configured to drive one or more of the plurality of tractive elements to propel the first vehicle; and
a lifting implement configured to support a product for movement via the drive motor;
a second vehicle including:
a chassis;
a plurality of tractive elements coupled to the chassis, the plurality of tractive elements configured to engage the ground surface to support the second vehicle; and
a lifting implement configured to support the product for movement; and
a tow bar including:
a first portion pivotably coupled to the first vehicle;
a second portion coupled to the second vehicle; and
a third portion extending between the first portion and the second portion, the third portion being laterally offset from a lateral center axis of the first vehicle and the second vehicle;
wherein, responsive to the drive motor propelling the first vehicle, the tow bar exerts a force on the second vehicle to maintain a space between the second vehicle and the first vehicle; and
wherein the third portion of the tow bar includes two or more members telescopically coupled to each other to accommodate for a change in a distance of the space between the second vehicle and the first vehicle.
